(19) United States
(12) Patent Application Publication
(10) Pub. No.: US 2020/0220782 A1
(43) Pub. Date: Jul. 9, 2020

(54) NETWORK TOPOLOGY SNAPSHOTS

(71) Applicant: Hewlett Packard Enterprise Development LP, Houston, TX (US)

(72) Inventors: Praveen Krishnakumar Parangattil, Bangalore (IN); Dheeraj Bapat, Bangalore (IN); Srinivasa Reddy Peddireddy, Bangalore (IN)

(21) Appl. No.: 16/243,271

(22) Filed: Jan. 9, 2019

(51) Int. Cl. H04L 12/24

(52) U.S. Cl. CPC H04L 41/12; H04L 45/48; H04L 41/22

(57) ABSTRACT

In some examples, a method can include recording network topology information of resources in a network to form a network topology snapshot, wherein the network topology information includes a protocol status associated with a resource of the resources; storing a plurality of network topology snapshots including a first network topology snapshot having a first protocol status of the resource and a second network topology snapshot having a second protocol status of the resource; and displaying an indication of a difference between the first protocol status and the second protocol status.

### BACKGROUND

A network device and/or a client device can operate in accordance with a wireless specification. A wireless specification such as those created by the Institute of Electrical and Electronics Engineers (IEEE) local area network/metropolitan area network Standards Committee (IEEE 802) provide media access control (MAC) and physical layer (PHY) specifications for implementing wireless local area network (WLAN) computer communication. A topology graph can used to display the relationship of a number of inter-related objects such as network devices and/or client devices.

### BRIEF DESCRIPTION OF THE DRAWINGS

FIG. 1 illustrates an example of a network consistent with the disclosure.

FIG. 2 is a block diagram of an example of a network device suitable for network topology snapshots consistent with the disclosure.

FIG. 3 is a block diagram of an example of a system consistent with the disclosure.

FIG. 4 is a block diagram of an example of a machine readable storage medium consistent with the disclosure.

FIG. 5 illustrates an example of a method consistent with the disclosure.

### DETAILED DESCRIPTION

A network device can use an antenna to transmit and/or receive information. The information can be transmitted and/or received via a network. Client devices can communicate via a network with the network device. Similar to the network device, the client devices can include an antenna to transmit and/or receive information. As used herein, the term “antenna” refers to a device that converts electric power into radio waves, and/or vice versa.

As mentioned, a topology graph can used to display a relationship of a number of inter-related objects such as network devices and/or client devices. An object can be any data and/or may represent any object. Objects can be hardware devices, and/or software programs, that are connected via a network. Examples of objects include client devices and/or various network devices such as servers, routers, storage devices, and/or databases, and/or applications. A topology graph can represent the objects via icons displayed on a display screen such as a graphical user interface and represents the relationships between objects as lines between the icons, among other possibilities.

Network topologies can change. For instance, a physical location of an object such as a client device and/or a network device can change, and/or an object can be added to or removed from a network. As such, some approaches may take network topology snapshots to identify when a physical location of an object changes. Such approaches may permit comparison of the physical device changes of objects and thereby permit a network administrator to identify a network issue associated with a physical change in the object. However, such approaches do not account for changes in a protocol status of an object. So, such approaches therefore do not permit a network administrator to identify a network issue associated with a protocol status change. Additionally, such approaches do not permit reverting of the network to an earlier snapshot having a different protocol status.

Accordingly, the disclosure is directed to network topology snapshots. For instance, network topology snapshots, as detailed herein, can including recording network topology information of resources in a network to form a network topology snapshot, where the network topology information includes a protocol status associated with a resource of the resources, storing a plurality of network topology snapshots including a first network topology snapshot having a first protocol status of the resource and a second network topology snapshot having a second protocol status of the resource, and displaying an indication of a difference between the first protocol status and the second protocol status, when present.

Notably, network topology snapshots include a protocol status of a resource, in contrast to other approaches such as those which merely detect changes in a presence and/or physical location of a resource on a network. Additionally, network topology snapshots as described herein can be recorded responsive to a predetermined event to permit quickly identifying issues in networks and/or promote better network planning/management such as facilitating an ability to revert from a snapshot to an earlier snapshot having a different protocol status.

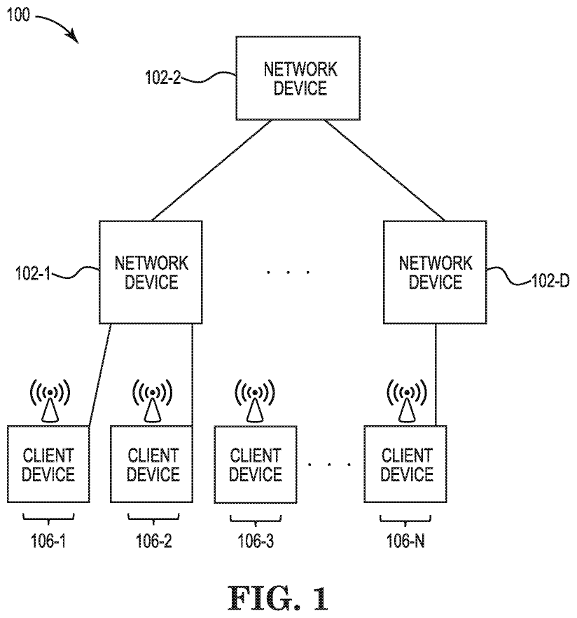

FIG. 1 illustrates an example of a network 100 consistent with the disclosure. As illustrated in FIG. 1, the network layout 100 can include network devices 102-1, 102-2 . . . , 102-D (referred to collectively as network devices 102), antennas 104, and client devices 106-1, 106-2, 106-3, . . . 106-N (referred to collectively as client devices 106). As used herein, the term “network device” can, for example, refer to a device that is adapted to transmit and/or receive signaling and to process information within such signaling such as a client device (e.g., any data processing equipment such as a computer, cellular phone, personal digital assistant, tablet devices, etc.), an access point, data transfer devices (such as network switches, routers, network controllers, etc.) or the like.

In some examples, network devices 102 can include a server such as a network management server (NMS). A NMS can refer to a computing device which monitors, and/or otherwise manages the operation of a computing environment. For example, a server can manage the operation of multiple devices via a wired connection or a wireless connection between the management server and the devices within a network. For instance, in some examples the NMS server includes instructions to detect a predetermined event, as described herein, or otherwise facilitate network topology snapshots.

In some examples, network devices 102 can include a database such as a Postgres database. For instance, the database can store a plurality of network topology snapshots as time series data, as described herein.

In some examples, network devices 102 can include an access point (AP). An AP can refer to a networking device that allows a client device (i.e., a wireless client device) to connect to a wired or wireless network. As used herein, the term “access point” (AP) can, for example, refer to receiving points for any known or convenient wireless access technology which can later become known. Specifically, the term AP is not intended to be limited to IEEE 802.11-based APs. APs function as an electronic device that is adapted to allow wireless devices to connect to a wired network via various communications standards. An AP can include a processing resource, memory, and/or input/output interfaces, including wired network interfaces such as IEEE 802.3 Ethernet interfaces, as well as wireless network interfaces such as IEEE 802.11 Wi-Fi interfaces, although examples of the disclosure are not limited to such interfaces. An AP can include a memory resource, including read-write memory, and a hierarchy of persistent memory such as ROM, EPROM, and Flash memory.

In some examples, network devices 102 can include a network controller. For example, network device 102-2 can be a network controller while network devices 102-1 and 102-D can be access points, among other possibilities. The network controller can include a processing resource such as a processing resource, memory, and input/output interfaces, including wired network interfaces such as IEEE 802.3 Ethernet interfaces, as well as wireless network interfaces such as IEEE 802.11 Wi-Fi interfaces, although examples of the disclosure are not limited to such interfaces. A network controller can include a memory resource, including read-write memory, and a hierarch of persistent memory such as ROM, EPROM, and Flash memory.

As used herein, the term “client device” can, for example, refer to a device including a processing resource, memory, and input/output interfaces for wired and/or wireless communication. For example, a client device can include a laptop computer, a desktop computer, a mobile device, and/or other wireless devices, although examples of the disclosure are not limited to such devices. A mobile device can, for example, refer to devices that are (or can be) carried and/or worn by a user. For instance, a mobile device can be a phone (e.g., a smart phone), a tablet, a personal digital assistant (PDA), smart glasses, and/or a wrist-worn device (e.g., a smart watch), among other types of mobile devices.

Client devices 106 can connect to network devices 102 via a network relationship. As used herein, the term “network relationship” can, for example, refer to a local area network (LAN), VLAN, wide area network (WAN), personal area network (PAN), a distributed computing environment (e.g., a cloud computing environment), storage area network (SAN), Metropolitan area network (MAN), a cellular communications network, and/or the Internet, among other types of network relationships.

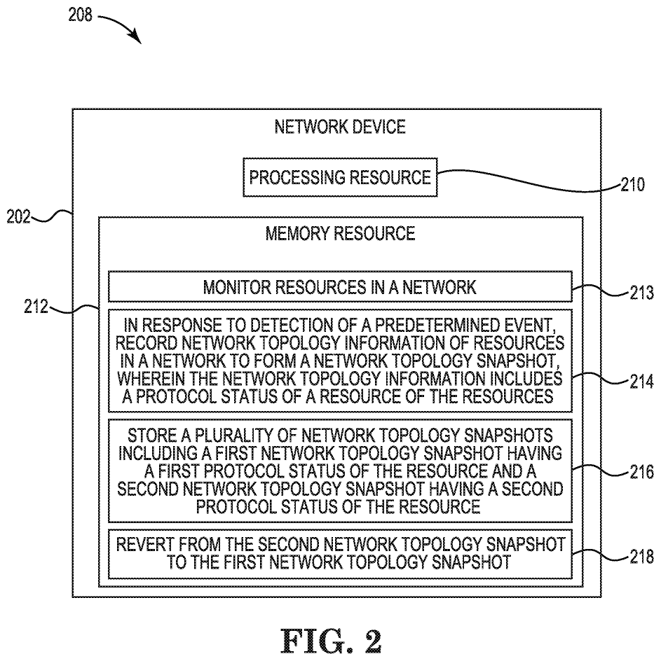

FIG. 2 is a block diagram 208 of an example network device 202 consistent with the disclosure. As described herein, the network device 202 (e.g., a network device of the network devices 102, described in connection with FIG. 1) can perform a function related to network topology snapshots. Although the following descriptions refer to an individual processing resource and an individual machine-readable storage medium, the descriptions can also apply to a system with multiple processing resources and multiple machine-readable storage mediums. In such examples, the network device 202 can be distributed across multiple machine-readable storage mediums and the network device 202 can be distributed across multiple processing resources. Put another way, the instructions executed by the network device 202 can be stored across multiple machine-readable storage mediums and executed across multiple processing resources, such as in a distributed or virtual computing environment.

As illustrated in FIG. 2, the network device 202 can comprise a processing resource 210, and a memory resource 212 storing machine-readable instructions 213, 214, 216, 218 to cause the processing resource 210 to perform an operation relating to network topology snapshots. That is, using the processing resource 210 and the memory resource 212, the network device 202 can in response to detection of a predetermined event, record network topology information of resources in a network to form a network topology snapshot, where the network topology information includes a protocol status of a resource of the resources, among other operations. It is noted the network topology information can include other information in addition to the protocol status such as configuration information of a resource, among other information. Processing resource 210 can be a central processing unit (CPU), microprocessor, and/or other hardware device suitable for retrieval and execution of instructions stored in memory resource 212.

While FIG. 2 describes instructions 213, 214, 216, 218 with respect to the network device 202, some or all of the instructions 213, 214, 216, 218 can be stored and/or executed in a distributed computing environment such as in a cloud infrastructure that can manage or otherwise interact with network devices and/or client devices. For instance, in various examples, network device 202 can record network topology information including a protocol status and/or configuration information of resources and send the recorded network topology information to a cloud computing environment. In some examples, recording network topology information can include recording network topology information of each resource of the plurality of resources on a network to form the network topology snapshot. The network topology snapshot can include protocol status and/or configuration information, among other information.

The network device 202 can include instruction 213 in the memory resource 212 and executable by the processing resource 210 to monitor resources in a network and detect a predetermined event. For instance, a NMS server or other network device can include instructions monitor for and detect a predetermined event via active and/or passive detection methods such as packet sniffing/sampling and/or actively sending packets to resources and receiving responses from the resources. Examples of predetermined events include a change in a protocol status, a change in a physical location of a resource, a change in a device configuration, and/or a change in a performance attribute of a resource such as a change in a utilization of a resource.

As mentioned, in some examples the predetermined event can be a protocol status change. Examples of changes in protocol statuses include a change in a spanning tree protocol (STP) of the resource, a change in a routing status of the resource, among other possibilities. Protocol status changes can occur responsive to and/or in conjunction with a change in a physical location of a resource on a network, as described herein. However, it is noted that in some examples a change in protocol status can occur in an absence of a physical change to a resource of the network such as a physical change in a location of a resource on the network and/or a presence of a resource on the network.

In some examples, the instruction can include instructions to monitor the resources via simple network management protocol (SNMP) poll to determine if there has been a protocol status change of the resource. Though the disclosure is not so limited and other forms or mechanisms such as a “ping” of a network resource can be employed to determine if there has been a change in a protocol status of a resource. That is, determining is there has been a change and/or occurrence of a predetermined event can occur based on information provide from a resource and/or network traffic sent to and/or received from the resource, among other possibilities.

As mentioned, in some examples a protocol status can be a STP of a resource. As used herein, a STP refers to a layer-2 protocol that runs between bridges to help create a loop-free network topology. For example, Bridge Protocol Data Units (BPDUs) are packets sent between Ethernet switches to elect a root bridge, calculate the best path to the root and block any ports that create loops. The resulting spanning tree, with the root at the top, spans all bridges in a network such as a local area network. A change in a STP can refer to a change in a path and/or other change in a spanning tree. As mentioned, in some examples, a protocol status can be a STP of a resource.

As mentioned, in some examples, a protocol status can be a routing status of an interface such as input/output interfaces for wired and/or wireless communication. For instance, an interface can have an active packet routing status (where a resource is able and/or actively routing packets via an interface) or an inactive packet status (where a resource is off-line/unable and/or not actively routing packets via an interface), among other possible routing statuses.

As mentioned, in some examples, a predetermined event can be a change in location of the resource or a change in a location of another resource of the plurality of resources. For examples, a change of a resource location on a network, addition of a resource to a network, and/or removal of a resource from a network, among other possible location changes can be a predetermined event, in some examples.

As mentioned, in some examples, a predetermined event can be a change in a virtual local area network (VLAN) port configuration. For instance, a change in an assignment (such as the assignment, reassignment, or assignment of a port) or other change in VLAN port configuration can be a predetermined event.

As mentioned, in some examples a predetermined event can be a change in a performance attribute of a resource. Examples of changes in a performance attribute include a change in a processing resource performance/utilization and/or a change in a memory resource performance/utilization (e.g., a memory “spike”), among other possibilities. However, the disclosure is not so limited.

Rather in some examples a change in a performance attribute of a resource can include a change in an amount of data usage, an amount of latency, a packet drop rate, or combinations thereof, among other possible performance attribute changes. As used herein and amount of data usage can refer to an amount of data transmitted, an amount of data received, and/or a combined amount of data transmitted and received by a client device and/or a network device. That is, in some examples an amount of data refers to a combined amount of data equal to the sum of an amount of data transmitted (tx) and an amount of data received (rx) by a respective client device of a plurality of client devices and/or respective network device of a plurality of network device.

As used herein, the term “information” such as “network topology information” can, for example, refer to data, addresses, control, management (e.g., statistics) or any combination thereof, among other information. For data transmission, information can be transmitted as a message, namely a collection of bits in a predetermined format. A message such as wireless message can include a header and payload data having a predetermined number of bits of information. The wireless message can be placed in a format as a plurality of packets, frames or cells. In some examples, determining can include determining a performance characteristic based on information included in a management packet or other type of packet.

The network device 202 can include instructions 214 in the memory resource 212 and executable by the processing resource 210 to record network topology information of resources in a network to form a network topology snapshot. Notably, the network topology information includes a protocol status (e.g., STP, etc.) of a resource. In various examples the instructions can include instructions to record the network topology information in response to detection of a predetermined event, such as those described herein.

Network device 202 can include instructions 216 stored in the memory resource 212 and executable by the processing resource 210 to store a plurality of network topology snapshots including a first network topology snapshot having a first protocol status of the resource and a second network topology snapshot having a second protocol status of the resource. For instance, in some examples the instructions can include instructions to store the plurality of network topology snapshots are stored as time series data. In such examples, the instructions can include instructions to monitor for and record protocol statues (e.g., changes in protocol statuses) over a period of time for a resource such as a network device.

For instance, in some examples the second network topology snapshot can be a current (or most recent) network topology snapshot while the first network topology snapshot can be a prior snapshot taken at an earlier time than the second network topology snapshot, among other possibilities. In any case, the time series data can be stored in a database and/or other type of storage resource such as in management plane in the distributed computing environment (a cloud computing environment). For instance, a representation (instructions corresponding to) a network topology snapshot can be stored in a table or other suitable format to maintain a correlation between a protocol status of given a network device, client device, and/or other resource.

The network device 202 can include instructions 220 stored in the memory resource 212 and executable by the processing resource 210 to display a network topology snapshot. For instance, the instructions can include instructions to display a first network topology snapshot (e.g., a prior network topology snapshot) and a second network topology snapshot (e.g., a current or most recent network topology snapshot). Stated differently, the first network topology snapshot can be taken at a time in advance of a time of the second network topology snapshot.

Displaying can include provide a visual representation of a resource such as network device and/or a client device and a corresponding protocol status of the resource and/or other identifying information of the resource. The visual representation can be displayed via a user interface of a client device, network device, and/or other device. Such display of a plurality of network topology snapshots can permit comparison of the network topology snapshots. For instance, in some examples, the instructions can display an indication of a difference between the first protocol status and the second protocol status, when present. The indication can be provided visually by highlight a difference (or similarity) between the first and/or the second protocol status, among other possibilities.

In some examples, the instructions can include instructions (not illustrated) to provide an indication of a time of occurrence of a difference between network topology snapshots and/or display a current protocol status of a resource. For instance, a time/day and/or version/identifier when the difference originally occurred can be visually displayed, alone or in addition to a current protocol status of the resource. In this manner, a network administrator or other entity can readily revert from a given network topology snapshot (e.g., a second network topology snapshot) to a prior network topology snapshot (e.g., a first network topology snapshot) to remedy/mitigate the anomaly.

That is, in some examples, the network device 202 can include instructions 218 stored in the memory resource 212 and executable by the processing resource 210 to revert to a network topology snapshot such as instructions to revert from a second network topology snapshot to a first network topology snapshot. That is, the protocol statuses can be reverted (e.g., from a current protocol status) to an early protocol status, independent of any physical change to resources. As used herein, reverting or revert to a network topology snapshot refers to configuring resources in accordance with network topology information of the network topology snapshot. For instance, in some examples the instructions can revert from a second network topology snapshot (e.g., a current or most recent network topology snapshot) to the first network topology snapshot (a snapshot taken at a time earlier than the second network topology snapshot). In some example, reverting to a snapshot (e.g., from the second network topology snapshot to the first network topology snapshot) can occur responsive to an input such as an input provided by a network administrator.

For instance, an input can be provided to cause reversion to an earlier network topology snapshot (e.g., a first network topology snapshot) responsive to detection of a network anomaly. Anomalies can refer to a loss in network functionality, changes in resource performance attributes such as resource utilization, etc. In some examples, an anomaly can occur on a monitored resource (e.g., a client device and/or network device) and/or can occur on the network (e.g., on an AP, a controller, a router, a server, a database, etc.). In any case, an anomaly which may be cause directly and/or indirectly by a change in a protocol status can be remedied/mitigated by reverting to an earlier network topology snapshot having a different protocol status (that did not result in an occurrence of the anomaly).

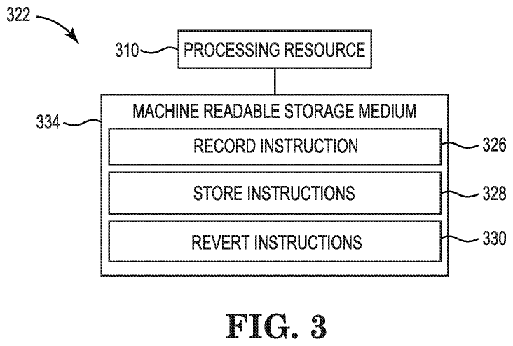

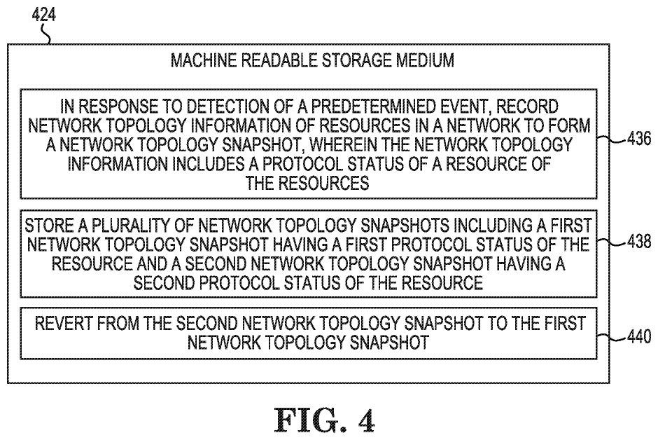

FIG. 3 is a block diagram of an example of a system 322, consistent with the disclosure. System 322 can include a processing resource 310 (e.g., processing resource 210, described in connection with FIG. 2) and a machine-readable storage medium 324 (e.g., machine-readable medium 424 as illustrated in FIG. 4, respectively. Although the following descriptions refer to an individual processing resource and an individual machine-readable storage medium, the descriptions can also apply to a system with multiple processing resources and multiple machine-readable storage mediums. In such examples, the instructions can be distributed across multiple machine-readable storage mediums and the instructions can be distributed across multiple processing resources. Put another way, the instructions can be stored across multiple machine-readable storage mediums and executed across multiple processing resources, such as in a distributed computing environment.

Processing resource 310 can be a central processing unit (CPU), microprocessor, and/or other hardware device suitable for retrieval and execution of instructions stored in machine-readable storage medium 324. In the particular example shown in FIG. 3, processing resource 310 can receive, determine, and send instructions 326, 328, 330. As an alternative or in addition to retrieving and executing instructions, processing resource 310 can include an electronic circuit comprising an electronic component for performing the operations of the instructions in machine-readable storage medium 324. With respect to the executable instruction representations or boxes described and shown herein, it should be understood that part or all of the executable instructions and/or electronic circuits included within one box can be included in a different box shown in the figures or in a different box not shown.

Machine-readable storage medium 324 can be any electronic, magnetic, optical, or other physical storage device that stores executable instructions. Thus, machine-readable storage medium 324 can be, for example, Random Access Memory (RAM), an Electrically-Erasable Programmable Read-Only Memory (EEPROM), a storage drive, an optical disc, and the like. The executable instructions can be “installed” on the system 322 illustrated in FIG. 3. Machine-readable storage medium 324 can be a portable, external or remote storage medium, for example, that allows the system 322 to download the instructions from the portable/external/remote storage medium. In this situation, the executable instructions can be part of an “installation package”. As described herein, machine-readable storage medium 324 can be encoded with executable instructions related to network topology snapshots.

Instructions 326, when executed by processing resource 310, can cause system 322 to in response to detection of a predetermined event, record network topology information of resources in a network to form a network topology snapshot, where the network topology information includes a protocol status of a resource of the resources, as described herein. For instance, the instructions 326 can record network topology information responsive to detection of a predetermined event such as a change in a protocol status, responsive to an input such as an input from a network administrator, and/or periodically (e.g., at a given day/time, etc.), among other possibilities.

Instructions 328, when executed by processing resource 310, can cause system 322 to store a plurality of network topology snapshots including a first network topology snapshot having a first protocol status of the resource and a second network topology snapshot having a second protocol status of the resource, as described herein. Instructions 330, when executed by processing resource 310, can cause system 322 to revert from the second network topology snapshot to the first network topology snapshot, as described herein.

FIG. 4 is a block diagram of an example of a machine-readable storage medium 424 consistent with the disclosure. The machine readable storage medium 424 can be analogous to or similar to machine readable storage medium 324. For instance, the machine-readable storage medium 424 can include instructions that are executable by a processing resource such as those described herein to perform functions related to network topology snapshots.

In various examples, the machine-readable storage medium 424 can include instructions 436, when executed by a processing resource, that can in response to detection of a predetermined event, record network topology information of resources in a network to form a network topology snapshot, where the network topology information includes a protocol status of a resource of the resources, as described herein. For instance, in some examples the predetermined event can be a change in a protocol status of the resource, among other possibilities. In various examples, the machine-readable storage medium 424 can include instructions 438, when executed by a processing resource, store a plurality of network topology snapshots including a first network topology snapshot having a first protocol status of the resource and a second network topology snapshot having a second protocol status of the resource, as described herein.

The machine-readable storage medium 424 can include instructions 440, when executed by a processing resource, revert from the second network topology snapshot to the first network topology snapshot, as described herein. For instance, in some examples the instructions can revert from a second network topology snapshot (e.g., a current or most recent network topology snapshot) to first network topology snapshot (e.g., a network topology snapshot taken at a time earlier than the second network topology snapshot).

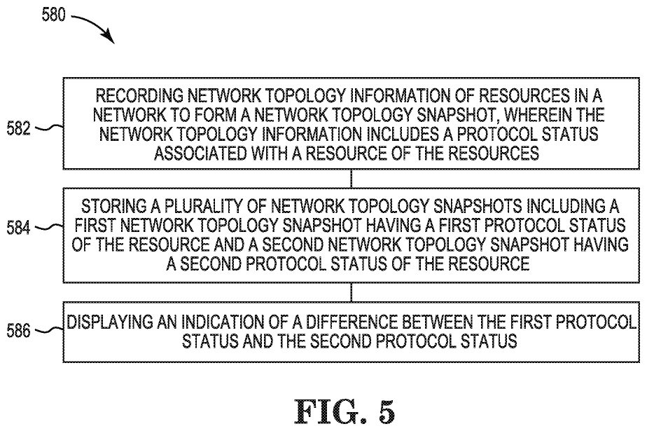

FIG. 5 illustrates an example of a method 580 consistent with the disclosure. Method 580 can be performed by a network device (e.g., network devices 102, 202, described in connection with FIGS. 1 and 2, respectively), a client device (e.g., client devices 106 described in connection with FIG. 1), and/or a different device such as a server.

At 582, the method 580 can include recording network topology information of resources in a network to form a network topology snapshot, for instance, where the network topology information includes a protocol status associated with a resource of the resources, as described herein. At 584, the method 580 can include storing a plurality of network topology snapshots including a first network topology snapshot having a first protocol status of the resource and a second network topology snapshot having a second protocol status of the resource, as described herein. At 586, the method 580 can include displaying an indication of a difference between the first protocol status and the second protocol status, as described herein. For example, a change in a STP and/or change in routing path can be displayed, among other possibilities.

Method 580 can be repeated. In some examples, method 580 can be repeated periodically, upon request such as request from a user/network administrator, responsive to detection of a predetermined event, and/or responsive to a change in a network condition.

In the foregoing detailed description of the disclosure, reference is made to the accompanying drawings that form a part hereof, and in which is shown by way of illustration how examples of the disclosure can be practiced. These examples are described in sufficient detail to enable those of ordinary skill in the art to practice the examples of this disclosure, and it is to be understood that other examples can be utilized and that process, electrical, and/or structural changes can be made without departing from the scope of the disclosure.

The figures herein follow a numbering convention in which the first digit corresponds to the drawing figure number and the remaining digits identify an element or component in the drawing. Similar elements or components between different figures can be identified by the use of similar digits. For example, 102 can reference element “02” in FIG. 1, and a similar element can be referenced as 202 in FIG. 2. Elements shown in the various figures herein can be added, exchanged, and/or eliminated so as to provide a plurality of additional examples of the disclosure. In addition, the proportion and the relative scale of the elements provided in the figures are intended to illustrate the examples of the disclosure and should not be taken in a limiting sense. As used herein, the designator “N”, particularly with respect to reference numerals in the drawings, indicates that a plurality of the particular feature so designated can be included with examples of the disclosure. The designators can represent the same or different numbers of the particular features. Further, as used herein, “a plurality of” an element and/or feature can refer to more than one of such elements and/or features.

What is claimed:

1. A method comprising:
recording network topology information of resources in a network to form a network topology snapshot, wherein the network topology information includes a protocol status associated with a resource of the resources;
storing a plurality of network topology snapshots including a first network topology snapshot having a first protocol status of the resource and a second network topology snapshot having a second protocol status of the resource; and
displaying an indication of a difference between the first protocol status and the second protocol status.

2. The method of claim 1, wherein the first network topology snapshot is taken at a time in advance of a time of the second network topology snapshot, and wherein the method further comprises reverting from the second network topology snapshot to the first network topology snapshot.

3. The method of claim 2, wherein the method further comprises reverting to the first snapshot responsive to detection of an anomaly on the resource or the network.

4. The method of claim 1, wherein the protocol status comprises a routing status of the resource.

5. The method of claim 1, wherein the protocol status comprises a spanning tree protocol (STP) of the resource.

6. The method of claim 1, further comprising recording network topology information of each resource of the plurality of resources to form the network topology snapshot.

7. The method of claim 1, further comprising displaying the indication, via a graphical user interface, as a visual indication of the difference.

8. The method of claim 1, further comprising providing an indication of a time of occurrence of the difference.

9. The method of claim 1, further comprising displaying a current protocol status of the resource.

10. A non-transitory machine-readable medium storing instructions executable by a processing resource to:
in response to detection of a predetermined event, record network topology information of resources in a network to form a network topology snapshot, wherein the network topology information includes a protocol status of a resource of the resources;
store a plurality of network topology snapshots including a first network topology snapshot having a first protocol status of the resource and a second network topology snapshot having a second protocol status of the resource; and
revert from the second network topology snapshot to the first network topology snapshot.

11. The medium of claim 10, wherein the second network topology snapshot is a current network topology snapshot.

12. The medium of claim 10, wherein the predetermined event is a change in a protocol status of the resource.

13. The method of claim 12, wherein the change in the protocol status occurs in the absence of a physical change to a resource of the network, wherein a physical change includes a location of the resource on the network or a presence of a resource on the network.

14. The medium of claim 10, wherein the predetermined event further comprises:
a change in a spanning tree protocol (STP) of the resource,
a change in a routing status of the resource;
a change in location of the resource or a change in a location of another resource of the plurality of resources;
a change in a virtual local area network (VLAN) port configuration;
a change in a processing resource performance or utilization; or
a change in a memory resource performance or utilization.

15. A network device including:
a processing resource; and
a non-transitory computer-readable medium storing instructions executable by the processing resource to:
monitor resources in a network;
in response to detection of a predetermined event, record network topology information of resources in a network to form a network topology snapshot, wherein the network topology information includes a protocol status of a resource of the resources;
store a plurality of network topology snapshots including a first network topology snapshot having a first protocol status of the resource and a second network topology snapshot having a second protocol status of the resource; and
revert from the second network topology snapshot to the first network topology snapshot.

16. The network device of claim 15, further comprising instructions to:
display a difference between the first protocol status and the second protocol status; and
receive an input to cause the second network topology snapshot to revert to the first snapshot responsive to an input.

17. The network device of claim 15, further comprising instructions to monitor the resources via simple network management protocol (SNMP) poll to determine if there has been a protocol status change of the resource.

18. The network device of claim 15, further comprising a database coupled to the network device to store the plurality of network topology snapshots.

19. The network device of claim 18, wherein the plurality of network topology snapshots are stored as time series data in the database.

20. The network device of claim 18, wherein the network device further comprises a server, wherein the server further comprises a network management system (NMS) server, wherein the NMS server includes instructions to detect the predetermined event.
